(19) United States
(12) Patent Application Publication
(10) Pub. No.: US 2014/0236500 A1
(43) Pub. Date: Aug. 21, 2014

(54) METHOD FOR PROCESSING AN ULTRASONIC ANALOG SIGNAL, DIGITAL SIGNAL PROCESSING UNIT AND ULTRASONIC INSPECTION DEVICE

(71) Applicants: Roman Heinrich Koch, Alzenau (DE); Gerhard Finger, Alzenau (DE); Klaus-Peter Busch, Alzenau (DE)

(72) Inventors: Roman Heinrich Koch, Alzenau (DE); Gerhard Finger, Alzenau (DE); Klaus-Peter Busch, Alzenau (DE)

(73) Assignee: GE SENSING & INSPECTION TECHNOLOGIES GMBH, Hurth (DE)

(21) Appl. No.: 14/348,182

(22) PCT Filed: Sep. 26, 2012
(86) PCT No.: PCT/EP2012/069001

§ 371 Date: Mar. 28, 2014

(30) Foreign Application Priority Data
Sep. 29, 2011 (EP) 102011054068.7

(51) Int. Cl. G01N 29/44; G01N 29/46; G06F 17/14

(52) U.S. Cl. CPC G01N 29/4445; G06F 17/148; G01N 29/46
USPC 702/39

(57) ABSTRACT

The invention relates to a method for processing an ultrasonic analog signal (10) representing a reflected ultrasonic wave, wherein the ultrasonic analog signal (10) is fed in a parallel manner into at least two signal paths (A;B) and the ultrasonic analog signal is supplied in each signal path (A;B) to respective amplifiers (20A;20B) whose gains are different from one another. The ultrasonic analog signals (11;11′) which have thus been amplified differently are supplied in each signal path (A;B) to a respective A/D converter (30A;30B) which converts the amplified ultrasonic analog signals (11; 11′) into digital ultrasonic data (12;12′), from which a combined digital ultrasonic signal (15) is reconstructed after further processing steps. According to the invention, a decomposition of the digital ultrasonic data (12; 12′) is carried out in each signal path (A;B) by the first level of a wavelet filter algorithm, and the wavelet coefficients are altered by a threshold analysis. A combined digital ultrasonic signal (15) is then reconstructed from the ultrasonic data thus decomposed, wherein an inverse transformation of the combined ultrasonic signal (15) is carried out by the second level of the wavelet filter algorithm with the altered wavelet coefficients. The invention moreover relates to an associated signal processing unit and an ultrasonic inspection device comprising such a signal processing unit.

### FIELD OF THE INVENTION

Embodiments of the present invention relate to a method for processing an ultrasonic analog signal representing an ultrasonic wave reflected in an inspected object.

Embodiments of the present invention also relate to an associated signal processing unit and an ultrasonic inspection device using such a signal processing unit.

### BACKGROUND OF THE INVENTION

A variety of methods for the non-destructive inspection of a test object by means of ultrasound are known from the field of material testing. In the pulse echo methods, a short ultrasonic pulse generated by an ultrasonic transmitter (transducer) is suitably insonified into a test object so that it propagates in the test object. If the pulse hits a flaw in the test object, for example a discontinuity, the pulse is reflected at least partially. The reflected pulse is detected by means of an ultrasonic receiver. The position of the discontinuity in the test object can be deduced from the travel time between the insonification of the pulse into the test object and the arrival of the reflected pulse at the receiver. The amplitude of the reflected pulse provides information on the size of the discontinuity.

Even though the pulse echo methods have been established methods in the field of material testing for many years, their application was generally limited to such inspection cases in which flaws are to be detected in the full test object volume. However, if flaws occur in the vicinity of such structures of the test object which themselves reflect the ultrasonic pulses used for the inspection, the detection of such flaws in the test object is difficult. This is due to the reflectivity of these structures, which lead to so-called “geometry echoes”, as well as to the finite temporal width of the pulses adjacent to these reflecting structures of the test object. In such a case, the pulse reflected at the flaw overlaps with the pulse reflected at the reflecting structure of the test object, so that a reliable detection of the flaw is often problematic or even impossible. Examples of such ultrasound-reflecting structures of the test object include the entrance surface, the back face or other geometric structures, such as the root concavity on weld seams, abrupt changes in thickness, excessive top layers, etc.

A flaw or a discontinuity in the test object is characterized by specific anomalous profiles in the electrical signal of the transducer, which can be made visible on a display. However, the electrical signal of the transducer representing the reflected sound wave has to be amplified in order to be input into a reproducing and recording device. In this case, the amplified signal has to fall into a dynamic range defined by the minimum and maximum operational parameters of the reproducing device used. However, possible geometry echoes can lead to a relatively weak signal of a flaw being incapable of being displayed if it is superimposed by other signals. Large amplitude differences of several received signals thus render smaller signals difficult to detect.

DE 10 2006 052 168 A1, for example, therefore proposes a digital log amplifier for ultrasound inspections in which an ultrasonic signal is simultaneously processed by several linear amplifiers. Each of the linear amplifiers has its own gain factor suitable for attaining the desired output signal level for input into one analog-digital converter (A/D converter), respectively, for further processing. The digital output signal of each A/D converter is examined by logic circuits as to which output has the largest output signal. This selected output signal is stored. Moreover, it is determined whether the output signal of each converter falls in between predefined limits. Output signals outside this limited band are eliminated, whereas signals within the band are also stored. The stored output signal curves are subsequently combined into a continuous linear digital output signal comprising a dynamic range which approximately corresponds to the sum of the individual dynamic ranges of the individual A/D converters. It is thus possible to detect, in particular, flaws close to the surface by the constant signal reflected by the surface of the test object being eliminated, so that smaller signals of flaws can be captured which would otherwise be obscured by the signal reflected from the surface.

In order to be able also to reliably detect flaws whose position in relation to the geometry of the test object is unfavorable, elaborate methods and devices are thus required in order to process and evaluate the reflected pulses. For this reason, an ultrasonic transmitter is often connected to various components and circuits of an evaluation unit which are supposed to eliminate unwanted signals, among other things. However, these components and circuits may in turn involve new problems with regard to the calibration and with respect to the reliability and consistency of the results, which have to be resolved. In particular in cases where several amplifiers are coupled with one another, as is the case in one embodiment according to DE 10 2006 052 168 A1, for example, the amplifiers used bring about different direct-current offsets (DC offsets). They are caused by circuit-related tolerances or different overshoots of the amplifiers and have to be reduced in order to increase the ratio S/N of wanted signals (S=signal) to unwanted signals (N=noise).

In order to compensate direct-current offsets of different amplifiers, WO 2007/047018 A2 proposes several digital-analog converters (D/A converters) that generate and supply a DC zero signal. Each time an inspection device is switched on or the gain is changed, an algorithm of a microprocessor determines the required DC correction value, which is then set in the D/A converters.

Furthermore, the use of a DC blocker behind the respective A/D converter in every attenuation path is known, for example, from embodiments in accordance with the above-mentioned document DE 10 2006 052 168 A1. In this case, normal FIR filters (finite impulse response filters) can be used as suitable DC blockers. If the signal is recombined into a signal after each attenuation path, extended FIR filters may also be applied to the combined output signal.

In order to attain as large a ratio S/N of wanted signals to unwanted signals as possible, the use of filtering techniques based on wavelet algorithms is also known in signal processing. Such a method is known, for example, from DE 102 25 344 A1. Furthermore, DE 10 2009 032 100 A1 discloses a method for filtering measurement signals in which several FIR filters are used in a cascading fashion, which thus form a filter bank. By using this structure, a signal is first transformed into the wavelet domain (decomposition). Within the wavelet domain, the wavelet coefficients are altered by the amplitude of the wavelet coefficients being evaluated within a level. If the amount of a coefficient is less than a predetermined threshold, the coefficient is set to zero. If the amount exceeds the threshold, the threshold is subtracted in the case of a positive coefficient, whereas it is added in the case of a negative coefficient. After this alteration, the coefficients are inversely transformed into the time domain (reconstruction), with the filter coefficients used being different in the inverse transformation from those in the transformation.

Furthermore, it is known in the processing of signals of ultrasound testing that amplified signals of several transducers are subjected to a wavelet filtering in order to accomplish a data reduction prior to storing the signals. This is disclosed, for example, in DE 103 34 902 B3.

### BRIEF DESCRIPTION OF THE INVENTION

Embodiments of the present invention further develop the ultrasound-based pulse-echo methods known from the prior art in such a way that, if several linear amplifiers are used that process an ultrasonic signal in parallel, the direct-current offset of the amplifiers is reduced in an advantageous manner in order thus to increase the ratio S/N of wanted signals to unwanted signals. In particular, a method for processing an ultrasonic analog signal and an associated signal processing unit are to be provided for this purpose.

In a first embodiment, the method according to the present invention for processing an ultrasonic analog signal representing an ultrasonic wave reflected in an inspected object provides that the ultrasonic analog signal is fed in a parallel manner into at least two signal paths. The ultrasonic analog signal is then supplied in each signal path to respective amplifiers whose gain factors differ from one another. The ultrasonic analog signals that are thus amplified differently are supplied in each signal path to a respective A/D converter that converts the amplified ultrasonic analog signals into digital ultrasonic data, from which a combined digital ultrasonic signal is reconstructed after further processing steps.

According to an embodiment of the present invention, a decomposition of the digital ultrasonic data is carried out in each signal path by the first level of a wavelet filter algorithm and the wavelet coefficients are altered by a threshold analysis prior to the combination of the individual signal data into a combined digital ultrasonic signal. In this way, an effective reduction of the direct-current offset, optionally adapted to the individual amplifier, can take place in each signal path at this point of the signal processing. The ultrasonic data decomposed in this way are then subjected to a joint inverse transformation by the second level of the wavelet filter algorithm with the altered wavelet coefficients, with the combined digital ultrasonic signal being formed in the process.

Therefore, an embodiment of the present invention is based on the surprising insight that a joint inverse transformation of the ultrasonic data obtained in the different amplifier stages by means of separate decomposition in the first level of a wavelet filter algorithm is possible by means of the second level of the wavelet filter algorithm with the altered wavelet coefficients in order to, on the one hand, recombine the two signal paths and, on the other hand, carry out the inverse transformation that is essential after the first level of the wavelet filter algorithm. In contrast, the implementation of a wavelet filtering process, which the person skilled in the art is familiar with in principle, would consist in a separate application of decomposition, threshold analysis and reconstruction in each individual amplifier branch. It is presumed that this unexpected possibility can be ascribed to the division of the input signal into (at least) two signal paths with different amplifiers corresponding to an amplitude decomposition as it is also carried out in the case of a wavelet filtering process. Thus, the signal splitting to different amplifier branches can possibly be considered to be analogous to a decomposition step in a first level of a wavelet filter algorithm.

In an alternative second embodiment of the method according to the present invention, a decomposition is carried out for the digital ultrasonic data in each signal path by the first level of a wavelet filter algorithm, and the wavelet coefficients are respectively altered by a threshold analysis, whereupon an inverse transformation of the decomposed ultrasonic data is carried out in each signal path by the second level of the wavelet filter algorithm with the altered wavelet coefficients. A combined digital ultrasonic signal, which has the advantage of a high dynamic range, is then reconstructed from the ultrasonic data obtained from each signal path.

All of the developments of the method according to the embodiments of the present invention discussed below can be realized both with the first as well as with the second embodiment of the present invention. Therefore, they are to be considered as being disclosed in combination both with the first as well as the second embodiment of the method according to the present invention.

In an embodiment, wavelet coefficients below a predefined threshold value are set to zero in the threshold analysis. Moreover, the wavelet filter database, in an embodiment, uses Daubechies-12 wavelets.

In one exemplary embodiment of the present invention, the digital ultrasonic data of both signal paths, for the decomposition by the wavelet filter algorithm by means of a wavelet filter database, are respectively fed to a first low-pass filter and a first high-pass filter. In each amplifier branch, the output of the first low-pass filter is in turn supplied to a second low-pass filter and a second high-pass filter, so that a wavelet filter database generates three outputs, respectively, for each signal path. The output of the second low-pass filter can be set to zero in both amplifier branches in order to eliminate the direct-current offset. A combined digital ultrasonic signal is formed from the four remaining outputs by means of a joint inverse transformation according to the second level of the wavelet filter algorithm.

For further processing of the combined digital ultrasonic signal, it can be supplied to another band-pass filter with shrinkable wavelet coefficients.

An embodiment of the present invention moreover comprises an associated digital signal processing unit comprising at least two signal paths into which the ultrasonic analog signal can be fed in a parallel manner. In each signal path, respective amplifiers are provided whose gain factors differ from one another, and respective A/D converters for converting amplified ultrasonic analog signals into digital ultrasonic data are provided in each signal path behind the amplifiers. The signal processing unit moreover comprises means for forming a combined digital ultrasonic signal from the digital ultrasonic data.

Means for decomposing the digital ultrasonic data by the first level of a wavelet filter algorithm and means for altering the wavelet coefficients by a threshold analysis are provided behind the respective A/D converter of each signal path. In a first embodiment of the signal processing unit according to the present invention, it moreover comprises means for the inverse transformation of the combined ultrasonic signal by the second level of the wavelet filter algorithm with the altered wavelet coefficients. In the second embodiment of the signal processing unit according to the present invention, it moreover comprises, for each signal path, means for the separate inverse transformation of the decomposed ultrasonic signal by the second level of the wavelet filter algorithm with the, optionally individually, altered wavelet coefficients. Subsequently, means for generating the combined ultrasonic signal from the inversely transformed ultrasonic data of both signal paths/amplifier branches are provided. Thus, the second embodiment of the signal processing unit according to the present invention is characterized in that means for decomposing the digital ultrasonic data by the first level of a wavelet filter algorithm and means for, possibly individually, altering the wavelet coefficients by a threshold analysis are provided behind the respective A/D converter of each signal path, and that thereafter, means for the joint inverse transformation of the decomposed ultrasonic signal data by the second level of the wavelet filter algorithm with the altered wavelet coefficients are provided in each signal path, which is followed by means for recombining these ultrasonic data inversely transformed in each signal path into a combined digital ultrasonic signal, which has the advantage of a high dynamic range.

All of the developments of the signal processing unit according to the present invention discussed below can be realized both with the first as well as with the second embodiment of the present invention. Therefore, they are to be considered as being disclosed in combination both with the first as well as the second embodiment of the signal processing unit according to the present invention.

In one exemplary embodiment of the present invention, the threshold values for the threshold analysis can be selected variably in the process.

All steps of the signal processing can in this case be carried out by a single unit or also be distributed among different units, or the signal processing includes the functionality of different elements. In this case, the units that carry out the steps according to an embodiment of the present invention, as a whole, are to be considered to be the signal processing unit according to an embodiment of the present invention.

In one exemplary embodiment of the present invention, a wavelet filter database is realized by several cascading low-pass filters and high-pass filters. In this case, the filter database respectively comprises a first low-pass filter and a first high-pass filter, the output of each first low-pass filter in turn being connected to a second low-pass filter and a second high-pass filter, so that three outputs, respectively, can be generated for each signal path by the wavelet filter database. The output of every second low-pass filter can be set to zero by means in the signal processing unit, in order to reduce the direct-current offset.

A band-pass filter with shrinkable wavelet coefficients can be provided behind the means for inverse transformation in the signal processing direction. In this case, the wavelets of the band pass filter are, in an embodiment, freely selectable.

An embodiment of the present invention furthermore includes an ultrasonic inspection device which, in addition to one or more transducers that are more particularly disposed in one or more test probes, comprises a digital signal processing unit according to an embodiment of the present invention. In an embodiment, it furthermore comprises a display unit and/or a storage unit for the ultrasonic signals processed by the signal processing unit.

The decomposition by means of wavelet transformation of an ultrasonic signal split to several signal paths provided according to an embodiment of the present invention, wherein the decomposition respectively takes place in signal paths for different amplifications of an ultrasonic analog signal, has various advantages over known solutions for reducing DC offsets. Above all, separate DC blockers can be omitted, and a reduction of the DC offset can be attained by a wavelet filter algorithm that would optionally be used anyway at some other point in the signal processing. By individual adaptation of the wavelet transformation used in the different amplifier branches, it is possible, in particular, to individually adjust the suppression of the DC signal component resulting from the wavelet transformation for each amplifier branch. In this way, an optimum adaptation to the individual properties of the analog signal amplifier used in the respective branch with regard to the DC offset to be compensated and to the post-oscillation behavior (“ringing”) to be compensated is possible. This is also advantageous particularly if the individual gains are adjustable. Thus, the wavelet transformation can be advantageously used for several purposes, by individual steps of the wavelet transformation taking place at different points of the signal processing. These advantages can be realized in both embodiments of the present invention, i.e. both in the first embodiment, in which the inverse transformation takes place jointly for the decomposed ultrasonic data generated in the two signal paths, with the result of this joint inverse transformation again being a combined digital ultrasonic signal, as well as in the second embodiment, in which the inverse transformation takes place separately for the decomposed ultrasonic data generated in these signal paths, wherein the results of this separate inverse transformation being recombined into a combined digital ultrasonic signal.

Moreover, this makes a high degree of flexibility with regard to the adjustment possible, so that an ultrasonic inspection device using the signal processing unit according to an embodiments of the present invention can be adapted to different applications when, for example, the threshold values for the threshold analysis are selected in a variable manner. Thus, it can be avoided that natural effects are possibly not taken into account after the calibration, as could otherwise be the case when standard filters are used.

Due to the conversion of the ultrasonic analog signal into at least two digital partial signals that are amplified differently and subjected to a threshold analysis, it is possible, in particular, to also capture defects close to the surface in an inspected object. The reflected signal curve of a defect close to the surface is very small in comparison to the boundary surface signal. The size of the boundary surface signal can be greater by an order of magnitude of one hundred than the size of the signal of the defect. Thus, the larger signal would overload the amplifier, and the signal of the defect contained in the larger signal curve would be lost or would not be detectable. By eliminating the boundary surface signal, however, weaker signals can also be displayed. This allows an examiner to obtain more precise inspection results for defects close to the surface.

### BRIEF DESCRIPTION OF THE DRAWINGS

Other advantages, special features and expedient further developments of the invention are apparent from the dependent claims and the following presentation of embodiments with reference to the illustrations. In the Figures:

FIG. 1 shows a schematic representation of an exemplary testing assembly using the signal processing unit according to an embodiment of the present invention for processing an ultrasonic analog signal;

FIG. 2 shows a schematic representation of the mode of operation of the components of an inventive signal processing unit according to the first embodiment of the present invention;

FIG. 3 shows an exemplary embodiment of a filter database for use in the method according to an embodiment of the present invention;

FIG. 4 shows a flow chart of the main steps of the method according to an embodiment of the present invention for processing an ultrasonic analog signal according to the first embodiment of the present invention,

FIG. 5 shows a schematic representation of the mode of operation of the components of an inventive signal processing unit according to the second embodiment of the present invention; and

FIG. 6 shows a flow chart of the main steps of the method according to an embodiment of the present invention for processing an ultrasonic analog signal according to the second embodiment of the present invention.

### DETAILED DESCRIPTION OF THE INVENTION

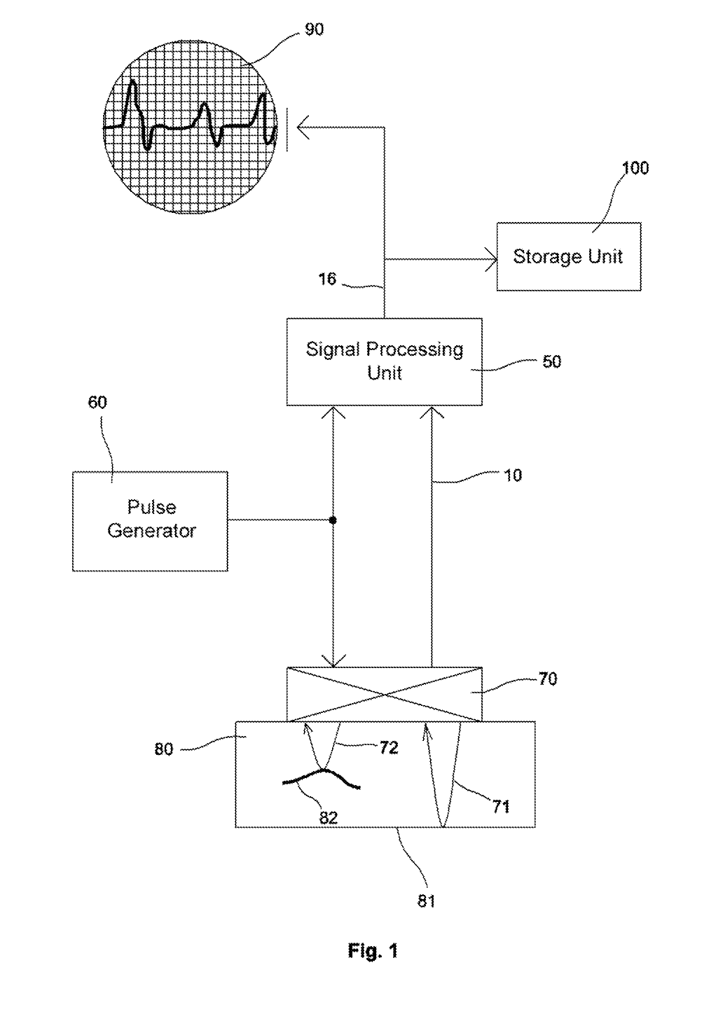

The use of the signal processing unit 50 according to an embodiment of the present invention and of the associated method for processing an ultrasonic analog signal are to be explained with reference to the testing assembly for an ultrasonic inspection shown schematically in FIG. 1. In it, a pulse generator 60 is being used which transmits a pulse to a test probe or transducer 70 in order to send an acoustic ultrasonic wave through an inspected object 80 therewith. The wave penetrates the inspected body 80 and is reflected by, for example, the rear face 81, which is illustrated in FIG. 1 by the wave 71. If a defect 82 is present within the inspected object 80, the ultrasonic wave is reflected on this defect 82, which is represented by the wave 72 in FIG. 1. Reflected waves can be received again by the same transducer 70, as is provided in the selected exemplary embodiment. However, other testing assemblies with several transducers can also be used, in which some transducers only transmit or receive, while others take on both transmitting and receiving functions.

Irrespective of the respective mode of operation of the transducers, the reflected acoustic wave is converted into an electrical signal 10 which is fed as an input signal 10 into the signal processing unit 50 configured according to an embodiment of the present invention. The signal processing unit 50 processes the ultrasonic analog signal 10 representing the reflected wave, and outputs, as an output signal 16, a digitized signal curve that can be displayed on a display 90. The display 90 is, for example, an oscilloscope. It can also be provided that the signal 16 processed by the signal processing unit 50 is stored in a storage unit 100 with or without the representation on a display 90.

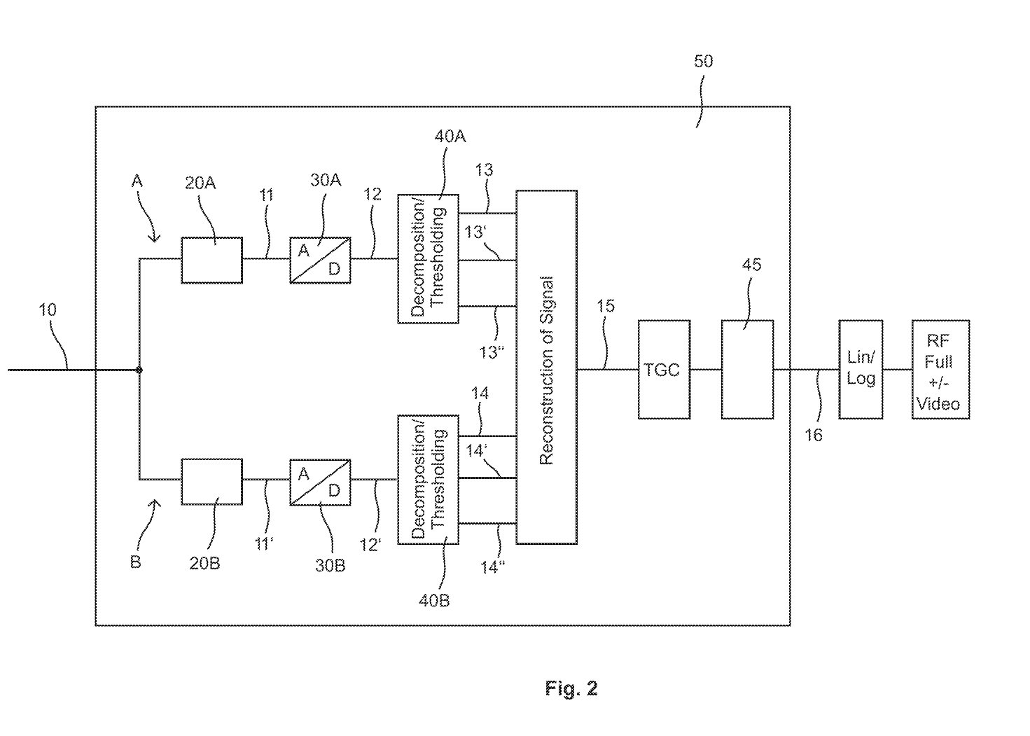

The digital signal processing unit 50 processes the ultrasonic analog signal 10 substantially by means of the components shown in FIG. 2. In this case, the analog ultrasonic signal 10 is supplied in parallel to at least two signal paths A and B that comprise different amplifications. Signal path B, for example, has a high amplification (high gain), whereas signal path A has a low amplification (low gain). In each signal path, the ultrasonic analog signal 10 is thus supplied to one amplifier 20A, 20B, respectively, which correspondingly amplifies the signal 10 into ultrasonic signals 11, 11′. Each amplified signal 11, 11′ is then supplied to a respective A/D converter 30A, 30B, which converts the respective amplified analog signal 11,11′ into digital signal data 12, 12′.

At the end of the two signal paths A, B, a combined signal 15, which can be subjected to further processing steps, is formed again from the digital signal data 12, 12′. However, due to the different signal paths and amplifiers 20A, 20B, different direct-current offsets are created in each signal path, which have to be compensated because they would otherwise disadvantageously reduce the ratio S/N.

For this purpose, the digital signal data 12, 12′ are subjected to a discrete wavelet transformation. In the process, the first level of the associated wavelet filter algorithm (decomposition) respectively takes place separately for each amplified and digitized signal 12, 12′ of the two signal paths, while the second level of the wavelet filter algorithm (inverse transformation/reconstruction) is jointly applied to the decomposed ultrasonic data 12, 12′ obtained in the decomposition. The result of this inverse transformation/reconstruction then is the combined digital ultrasonic signal 15.

The wavelet coefficients are downloadable; and Daubechies-12 wavelets are used with preference. After the decomposition, the wavelet coefficients of each signal path are altered by a threshold analysis (thresholding), with the threshold values used, more particularly, being variably and individually adjustable. This makes flexible settings for the signal processing unit possible, whereby an adaptation to different applications of an ultrasonic inspection device are possible. In the alteration of the coefficients, it is at least provided that wavelet coefficients below a certain threshold value are set to zero.

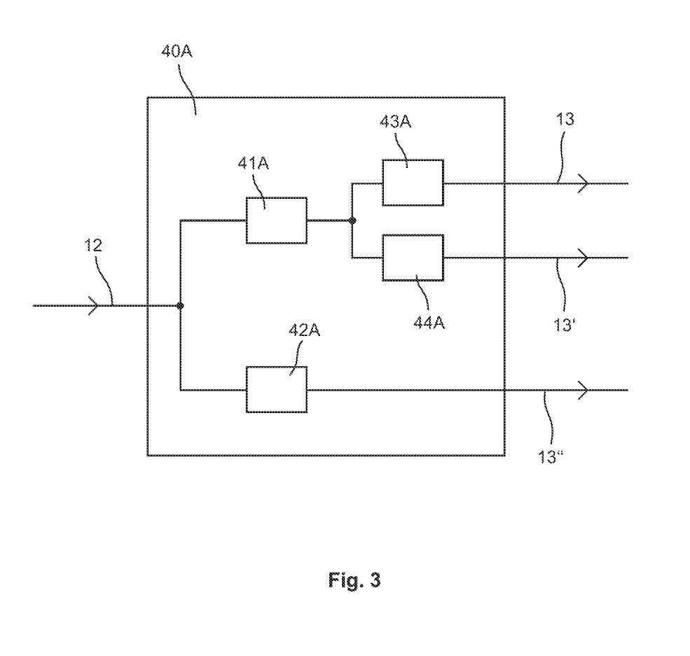

In order to implement the wavelet filter algorithm, a filter database 40A, 40B is used for each signal path, which comprises several levels of cascaded low-pass and high-pass filters, as is shown schematically in FIG. 3 for the signal 12 of the signal path A and the associated filter database 40A. Signal processing for the signal data 12′ of the second signal path B is carried out in an analogous manner.

In an embodiment, the digital ultrasonic data 12, for the decomposition by the wavelet filter algorithm, are fed to a first low-pass filter 41A and a first high-pass filter 42A which form a first level of a cascaded filter bank. The output signal of each first low-pass filter 41A is in turn supplied to a second low-pass filter 43A and second high-pass filter 44A, which form the second level of the cascaded filter bank. Thus, three outputs 13, 13′ and 13″ are generated by the filter database 40A. The output 13 of the second low-pass filter 43A is immediately set to zero in the process, whereby the direct-current offset for this signal path A is eliminated.

Thus, at least two levels with respective low-pass and high-pass filters are realized by the filter database 40A. However, the number of levels can also be increased, wherein the output of the second low-pass filter 43A can again be supplied to another low-pass and high-pass filter, etc. Moreover, it is possible to expand this discrete wavelet transformation into a wavelet packet transformation, in which the outputs of the high-pass filters, too, are again supplied to a low-pass and a high-pass filter in each level respectively.

The same decomposition and threshold analysis takes place for the digitized signal 12′ of the second signal path B, so that three signal data 13, 13′, 13″ and 14, 14′, 14″ are generated for each signal path, two of which are immediately set to zero for the purpose of reducing the DC offset. Thus, the total result for both signal paths is four signal data 13′, 13″. 14′ and 14″, which are recombined into a digital ultrasonic signal 15 in the next processing step, as is shown by FIG. 2. In this processing step, the second level of the wavelet filter algorithm is jointly applied to the set of all four signal data 13′, 13″, 14′, and 14″ in the form of an inverse transformation, with the altered coefficients being used.

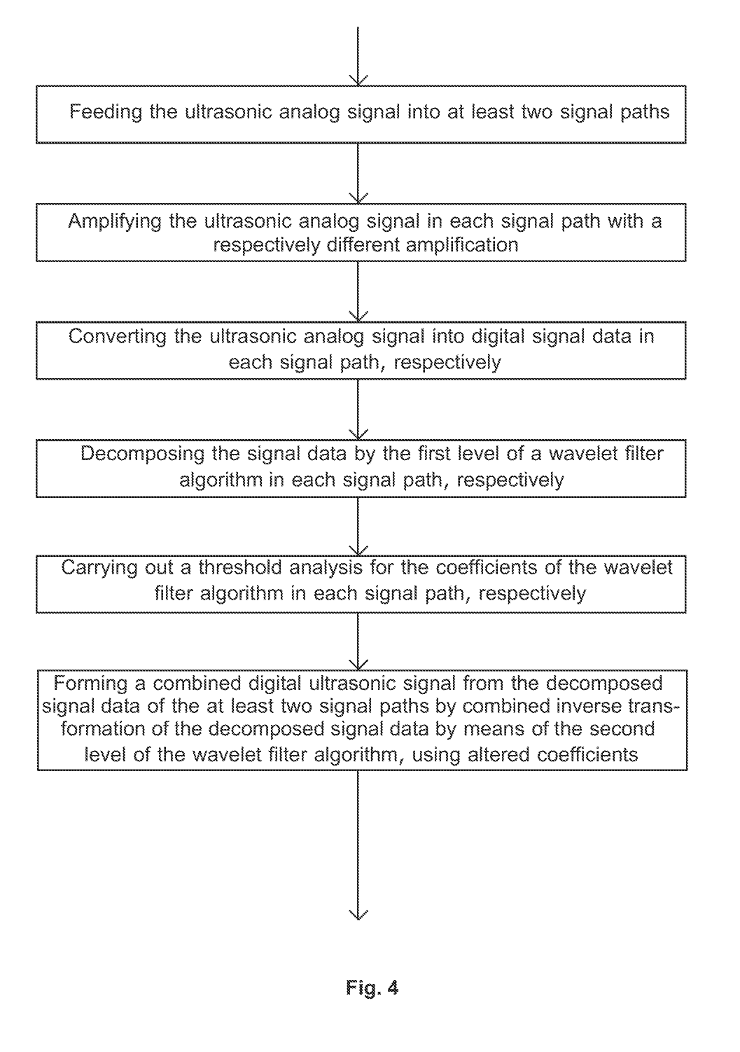

These main steps of the first embodiment of the method according to the present invention for processing an ultrasonic analog signal and their order are also shown in the flow chart of FIG. 4.

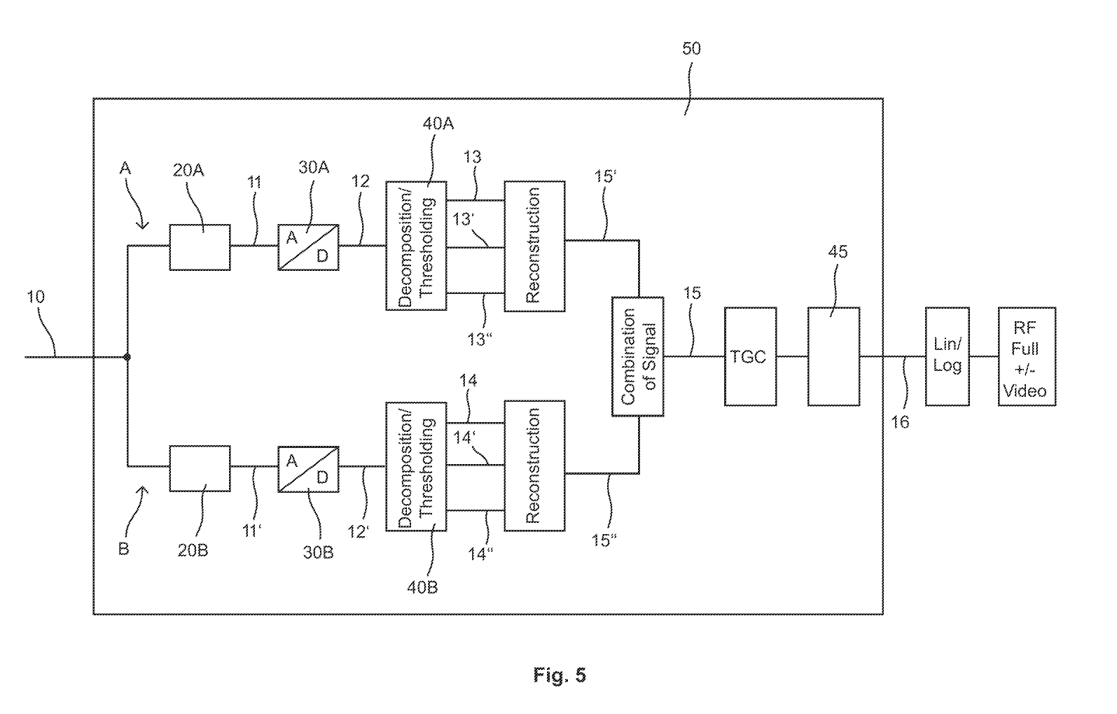

FIG. 5 shows a schematic representation of the mode of operation of the components of an inventive signal processing unit according to the second embodiment of the present invention. This corresponds completely to the first embodiment of the present invention shown in FIG. 2, with the exception of the differences described below. In the two signal paths A and B, three signal data 13, 13′, 13″ and 14, 14′, 14″, two of which, however, are immediately set to zero for the purpose of reducing the DC offset, are generated for each signal path by separate decomposition and threshold analysis from the digitized signals 12, 12′. Thus, two signal data 13′ and 13″, respectively, as well as 14′ and 14″, respectively, result in each case for the two signal paths, which are separately inversely transformed in each signal path into a digital ultrasonic signal 15′ and 15″ by the second level of the wavelet filter algorithm, with the altered coefficients being used. The digital ultrasonic signals 15′ and 15″ thus generated are then combined in a suitable unit in order to generate the combined digital ultrasonic signal 15 with a high dynamic range, as FIG. 5 shows.

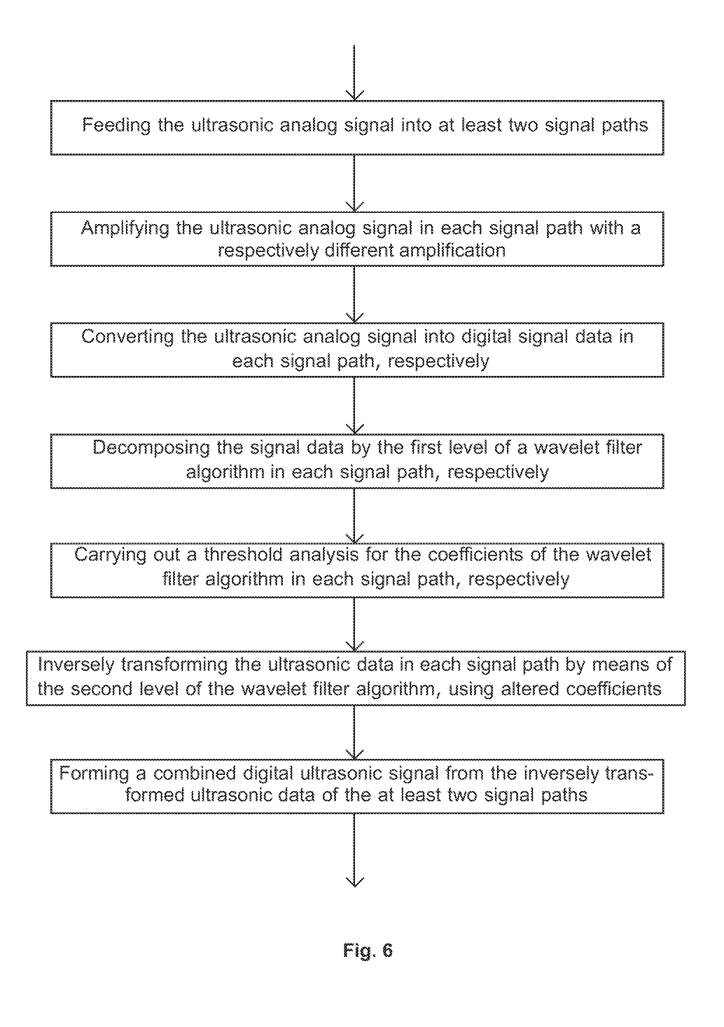

The main steps of the second embodiment of the method according to an embodiment of the present invention for processing an ultrasonic analog signal and their order are also shown in the flow chart of FIG. 6.

The digital ultrasonic signal 15 obtained in this manner can then be subjected to further processing steps in both embodiments of the present invention. For example, a time gain compression (TGC) can take place and the signal can be supplied to another band-pass filter 45. Shrinkable coefficients and individually selectable wavelets can be used for the band-pass filter. Moreover, the wavelet coefficients are subjected to a threshold analysis also in this case.

Following this signal processing, the generated output signal 16 can be displayed on a display 90, such as an oscilloscope, and/or stored in a storage unit 100. Due to the completed compensation of the direct-current offset, the ratio S/N of wanted signals to unwanted signals is increased as compared with solutions without any compensation, which facilitates the detection of smaller signals for defects close to the surface, in particular.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. Method for processing an ultrasonic analog signal (10) representing a reflected ultrasonic wave, wherein the ultrasonic analog signal (10) is fed in a parallel manner into at least two signal paths (A;B) and the ultrasonic analog signal is supplied in each signal path (A;B) to respective amplifiers (20A;20B) whose gains are different from one another, and the ultrasonic analog signals (11;11′) which have thus been amplified differently are supplied in each signal path (A;B) to a respective A/D converter (30A;30B) which converts the amplified ultrasonic analog signals (11;11′) into digital ultrasonic data (12;12′), from which a combined digital ultrasonic signal (15) is reconstructed after further processing steps,
characterized in that a decomposition is carried out for the digital ultrasonic data (12;12′) in each signal path (A;B) by a first level of a wavelet filter algorithm, and the wavelet coefficients are altered by a threshold analysis, and that a joint inverse transformation of the decomposed ultrasonic data (12, 12′) is carried out by the second level of the wavelet filter algorithm with the altered wavelet coefficients, wherein a combined digital ultrasonic signal (15) is reconstructed from the decomposed ultrasonic data.

2. Method according to claim 1,
characterized in that wavelet coefficients below a predefined threshold value are set to zero in the threshold analysis.

3. Method according to any one of the claims 1 and 2,
characterized in that the wavelet filter database uses Daubechies-12 wavelets.

4. Method according to any one of the claims 1 to 3,
characterized in that the digital ultrasonic data (12;12′) of both signal paths (A;B), for the decomposition by the wavelet filter algorithm by means of a wavelet filter database (40A;40B), are respectively fed to a first low-pass filter (41A) and a first high-pass filter (42A), and the output signal of each first low-pass filter (41A) is in turn supplied to a second low-pass filter (43A) and second high-pass filter (44A), so that the wavelet filter database (40A;40B) generates three outputs (13;13′;13″;14;14′;14″), respectively, for each signal path (A;B), wherein the output (13;14) of every second low-pass filter (43A) is set to zero, and a combined ultrasonic signal (15) is formed from the four remaining outputs (13′;13″;14′;14″) by means of the second level of the wavelet filter algorithm.

5. Method according to any one of the claims 1 to 4,
characterized in that the combined ultrasonic signal (15) is supplied to a band-pass filter (45) with shrinkable wavelet coefficients.

6. Digital signal processing unit (50) for processing an ultrasonic analog signal (10) representing a reflected wave, wherein the signal processing unit (50) comprises at least two signal paths (A;B) into which the ultrasonic analog signal (10) can be fed in a parallel manner, and respective amplifiers (20A; 20B) are provided in each signal path (A;B) whose gains differ from one another, and respective A/D converters (30A;30B) for converting amplified ultrasonic analog signals (11;11′) into digital ultrasonic data (12;12′) are provided in each signal path (A;B) behind the amplifiers (20A;20B), and the signal processing unit (50) moreover comprises means for forming a combined digital ultrasonic signal (15) from the digital ultrasonic data (12;12′),
characterized in that means for decomposing the digital ultrasonic data (12;12′) by the first level of a wavelet filter algorithm and means for altering the wavelet coefficients by a threshold analysis are provided behind the respective A/D converter (30A;30B) of each signal path (A;B), and that, behind them, means for the joint inverse transformation of the decomposed ultrasonic data (12;12′) by the second level of the wavelet filter algorithm with the altered wavelet coefficients are provided for forming the combined ultrasonic signal (15).

7. Digital signal processing unit according to claim 6,
characterized in that the threshold values for the threshold analysis can be selected variably.

8. Digital signal processing unit according to any one of the claims 6 and 7,
characterized in that the wavelet filter database (40A;40B) respectively comprises a first low-pass filter (41A) and a first high-pass filter (42A), the output of each first low-pass filter (41A) in turn being connected to a second low-pass filter (43A) and a second high-pass filter (44A), so that three outputs (13;13′;13″;14;14′;14″), respectively, can be generated for each signal path (A;B) by the wavelet filter database (40A;40B), and that the signal processing unit (50) comprises means for setting the output (13;14) of each second low-pass filter (43A) to zero.

9. Digital signal processing unit according to any one of the claims 6 to 8,
characterized in that a band-pass filter (45) with shrinkable wavelet coefficients is provided behind the means for joint inverse transformation of the decomposed ultrasonic data (12, 12′) for generating the combined ultrasonic signal (15).

10. Digital signal processing unit according to claim 9,
characterized in that the wavelets of the band pass filter (45) are freely selectable.

11. Ultrasonic inspection device,
characterized in that it comprises a digital signal processing unit according to any one of the claims 6 to 10.
